(19) United States
(12) Patent Application Publication
(10) Pub. No.: US 2026/0167488 A1
(43) Pub. Date: Jun. 18, 2026

(54) DEHYDROGENATION REACTION SYSTEM AND CONTROL METHOD THEREOF

(71) Applicants: Hyundai Motor Company, Seoul (KR); Kia Corporation, Seoul (KR)

(72) Inventors: Jihui SEO, Hwaseong-Si (KR); Pyung Soon KIM, Hwaseong-Si (KR); Ji-Hoon JANG, Hwaseong-Si (KR); Jaeyong LEE, Hwaseong-Si (KR); Hanjin KIM, Hwaseong-Si (KR); Narae YOON, Hwaseong-Si (KR); Jihye PARK, Hwaseong-Si (KR)

(21) Appl. No.: 19/297,389

(22) Filed: Aug. 12, 2025

(30) Foreign Application Priority Data
Dec. 16, 2024 (KR) 10-2024-0187015

(51) Int. Cl. C01B 3/323; B01J 14/00; B01J 19/00; B01J 19/24; H01M 8/04082; H01M 8/04746; H01M 8/0606

(52) U.S. Cl. CPC C01B 3/323; B01J 14/00; B01J 19/002; B01J 19/24; H01M 8/04201; H01M 8/04753; H01M 8/0606; B01J 2219/00162; B01J 2219/002; C01B 2203/066; C01B 2203/1638; C01B 2203/1657

(57) ABSTRACT

An apparatus of a fuel cell system may comprise a dehydrogenation reactor configured to generate hydrogen gas based on a chemical reaction of a chemical hydride and an aqueous acid solution, an acid aqueous solution tank configured to supply the acid aqueous solution to the dehydrogenation reactor, a chemical hydride tank configured to supply the chemical hydride to the dehydrogenation reactor, a hydrogen tank configured to store the hydrogen gas under a first pressure, a hydrogen back pressure regulator along a hydrogen discharge path, a product tank configured to store a product generated in the dehydrogenation reactor, a processor, and a memory storing at least one instruction to control a pressure of the dehydrogenation reactor to maintain a reference pressure by supplying an acid aqueous solution or water before product discharge.

### CROSS-REFERENCE TO RELATED APPLICATION

This application claims benefit of priority to Korean Patent Application No. 10-2024-0187015 filed in the Korean Intellectual Property Office on Dec. 16, 2024, the entire contents of which are incorporated herein by reference.

### TECHNICAL FIELD

The present disclosure relates to a dehydrogenation reaction system and a control method thereof, and more particularly, to a dehydrogenation reaction system and a control method thereof that may rapidly discharge byproducts other than hydrogen gas generated by a chemical reaction between an acid aqueous solution and a chemical hydride.

### BACKGROUND

The matters described in this Background section are only for enhancement of understanding of the background of the disclosure, and should not be taken as acknowledgment that they correspond to prior art already known to those skilled in the art.

Due to depletion of fossil energy and environmental pollution problems, there is a great demand for renewable and alternative energy, and hydrogen is attracting attention as one of such alternative energies.

A fuel cell and a hydrogen combustion device use hydrogen as a reaction gas, and in order to apply the fuel cell and the hydrogen combustion device to vehicles and various electronic products, a stable and continuous supply technology of hydrogen is required.

In order to supply hydrogen to a device that uses hydrogen, a method of being supplied with hydrogen whenever hydrogen is needed from a separately installed hydrogen supply source may be used. In this way, compressed hydrogen or liquefied hydrogen may be used.

Alternatively, a method may be used in which a material storing hydrogen is loaded into a hydrogen utilization device, hydrogen is generated through a chemical reaction of the material, and this is supplied to the hydrogen utilization device. For example, a method of dissolving solid hydride in an aqueous solution and using dissolved hydride and a method of using adsorption, absorbents/carbon, and a chemical hydrogen storage may be used.

For example, a system for producing hydrogen by injecting an acid solution into NaBH4 may be considered. This hydrogen production system may be a batch system that includes an acid solution tank, a reactor containing NaBH4, a water separator, an acid purifier, and the like. In the batch system, the products, after the dehydrogenation reaction, may accumulate within the reactor.

Therefore, since the dehydrogenation reaction and product accumulation proceed simultaneously within the existing reactor, when the product needs to be discharged, the reactor itself needs to be removed and replaced, or the product needs to be recovered from the reactor.

If a small amount of NaBH4 (Sodium borohydride, SBH) is used or the output is low, the reactor size is relatively small and replacement is not difficult. However, if several kg or more of SBH are reacted to increase the amount of hydrogen, there is a problem in terms of convenience of replacement due to the increase in the weight and size of the reactor.

Particularly, in the case of the product, solidification/fixation may occur when cooled to room temperature, making clean removal difficult and hindering the restart reaction. A method of melting the product through heating may also be used, but this requires a separate heat source, which increases the energy consumed in the system.

### SUMMARY

An object to be solved attempts to provide a dehydrogenation reaction system that may rapidly discharge products generated along with the dehydrogenation reaction in a dehydrogenation reactor.

According to the present disclosure, an apparatus of a fuel cell system, the apparatus may comprise a dehydrogenation reactor configured to generate, based on a chemical reaction of a chemical hydride and an aqueous acid solution, hydrogen gas, an acid aqueous solution tank configured to supply the acid aqueous solution to the dehydrogenation reactor, a chemical hydride tank configured to supply the chemical hydride to the dehydrogenation reactor, a hydrogen tank configured to store the hydrogen gas generated in the dehydrogenation reactor, wherein the hydrogen gas stored in the hydrogen tank is stored under a first pressure, a hydrogen back pressure regulator disposed along a hydrogen discharge path between the dehydrogenation reactor and the hydrogen tank, a product tank configured to store a product generated in the dehydrogenation reactor, a processor, and a memory storing at least one instruction that, when executed by the processor communicating with the memory, is configured to cause the apparatus to, control a pressure of the dehydrogenation reactor, to maintain a reference pressure after a dehydrogenation reaction in the dehydrogenation reactor is completed and the product generated in the dehydrogenation reactor is discharged, wherein the pressure of the dehydrogenation reactor is controlled by, before discharging the product generated in the dehydrogenation reactor into the product tank, supplying an acid aqueous solution or water to the dehydrogenation reactor so that the product has a set volume within the dehydrogenation reactor while the hydrogen gas is maintained at a target pressure.

The apparatus, wherein the at least one instruction, when executed by the processor communicating with the memory, is configured to cause the apparatus to, supply the acid aqueous solution and the chemical hydride to the dehydrogenation reactor, and supply additional acid aqueous solution or water to the dehydrogenation reactor after the dehydrogenation reaction is completed. The apparatus, wherein the product is discharged until an internal pressure of the dehydrogenation reactor reaches a set pressure.

The apparatus, further may comprise a product back pressure regulator disposed along a product discharge path between the dehydrogenation reactor and the product tank. The apparatus, further may comprise a buffer tank configured to store hydrogen gas from the dehydrogenation reactor, wherein the hydrogen gas stored in the buffer tank is stored under a second pressure that is lower than the first pressure.

The apparatus, wherein the at least one instruction, when executed by the processor communicating with the memory, is configured to cause the apparatus to discharge hydrogen gas from the dehydrogenation reactor to the buffer tank until a pressure of the dehydrogenation reactor reaches the reference pressure. The apparatus, wherein the chemical hydride and acid aqueous solution are each supplied in liquid form to reduce or remove handling of solid-phase reactants. The apparatus, wherein the hydrogen gas is stored at a pressure in a range of 500 bar to 875 bar in the hydrogen tank.

According to the present disclosure, a method performed by an apparatus of a fuel cell system, the method may comprise determining whether a pressure of a hydrogen tank of the fuel cell system is less than a target pressure, based on the pressure of the hydrogen tank being less than the target pressure, supplying an acid aqueous solution to a dehydrogenation reactor of the fuel cell system and supplying a chemical hydride to the dehydrogenation reactor, storing hydrogen gas generated in the dehydrogenation reactor in the hydrogen tank, and controlling a pressure of the dehydrogenation reactor, to maintain a reference pressure after a dehydrogenation reaction in the dehydrogenation reactor is completed and a product generated in the dehydrogenation reactor is discharged, wherein the controlling of the pressure of the dehydrogenation reactor may comprises supplying an acid aqueous solution or water to the dehydrogenation reactor so that the product has a set volume within the dehydrogenation reactor while the hydrogen gas is maintained at a set pressure, and discharging the product to a product tank.

The method may further comprise discharging the product until a pressure of the dehydrogenation reactor reaches a set pressure. The method, wherein the supplying of the acid aqueous solution or water and the supplying of chemical hydride reduce or remove handling of a solid-phase chemical hydride. The method may further comprise discharging hydrogen gas to another dehydrogenation reactor or a buffer tank to reduce an internal pressure of the dehydrogenation reactor before discharging the product. The method, wherein the discharging of hydrogen gas is performed based on a temperature of the dehydrogenation reactor being below a set threshold.

According to the present disclosure, an apparatus of a fuel cell system, the apparatus may comprise a plurality of dehydrogenation reactors configured to generate, based on a chemical reaction of a chemical hydride and an aqueous acid solution, hydrogen gas, an acid aqueous solution tank configured to supply an acid aqueous solution to the plurality of dehydrogenation reactors, a chemical hydride tank configured to supply a chemical hydride to the plurality of dehydrogenation reactors, a hydrogen tank configured to store hydrogen gas generated in the plurality of dehydrogenation reactors, a hydrogen back pressure regulator disposed along a hydrogen discharge path between the plurality of dehydrogenation reactors and the hydrogen tank, a product tank configured to store products generated in the plurality of dehydrogenation reactors, a processor, and a memory storing at least one instruction that, when executed by the processor communicating with the memory, is configured to cause the apparatus to, control a pressure of one of the plurality of dehydrogenation reactors to maintain a reference pressure after a dehydrogenation reaction in the one of the plurality of dehydrogenation reactors is completed and a respective product generated in the one of the plurality of dehydrogenation reactors is discharged, wherein the pressure of the one of the plurality of dehydrogenation reactors is controlled by, before discharging the respective product to the product tank, discharge hydrogen gas from the one of the plurality of dehydrogenation reactors to another of the plurality of dehydrogenation reactors while maintaining a set volume ratio between the respective product and the hydrogen gas in the one of the plurality of dehydrogenation reactors.

The apparatus, wherein the at least one instruction, when executed by the processor communicating with the memory, is configured to cause the apparatus to, based on a temperature of the one of the plurality of dehydrogenation reactors being less than a set temperature, discharge the hydrogen gas from the one of the plurality of dehydrogenation reactors to the other of the plurality of dehydrogenation reactors. The apparatus, wherein the respective product is discharged to the product tank until a pressure of the one of the plurality of dehydrogenation reactors reaches a set value.

The apparatus, wherein the plurality of dehydrogenation reactors are configured to operate alternately to support continuous hydrogen generation. The apparatus, wherein the at least one instruction, when executed by the processor communicating with the memory, is configured to cause the apparatus to control, based on measured internal pressure or temperature of a first dehydrogenation reactor of the plurality of dehydrogenation reactors, discharge of hydrogen gas from the first dehydrogenation reactor.

The apparatus, wherein the hydrogen gas is discharged from the one of the plurality of dehydrogenation reactors to the other of the plurality of dehydrogenation reactors to adjust a pressure of the one of the plurality of dehydrogenation reactors before discharging a product from the one of the plurality of dehydrogenation reactors. The apparatus, wherein a volume of a product generated in the one of the plurality of dehydrogenation reactors is determined based on a preset internal volume of the one of the plurality of dehydrogenation reactors and a preset gas volume of hydrogen gas maintained under pressure within the one of the plurality of dehydrogenation reactors.

In addition, the effects that may be obtained or expected from the examples of the present disclosure will be directly or implicitly disclosed in the detailed description of the present disclosure. For example, various effects expected from the examples of the present disclosure will be described in the following detailed description.

### BRIEF DESCRIPTION OF THE DRAWINGS

These drawings are for reference only in describing examples of the present disclosure, and therefore the technical idea of the present disclosure should not be limited to the accompanying drawings.

FIG. 1 shows an example of a dehydrogenation reaction system according to a first example.

FIG. 2 shows an example of an operation of the dehydrogenation reaction system according to the first example.

FIG. 3 shows an example of an operation of a dehydrogenation reaction system according to a second example.

FIG. 4 shows an example of a dehydrogenation reaction system according to a third example.

FIG. 5 shows an example of an operation of the dehydrogenation reaction system according to the third example.

FIG. 6 shows an example of a dehydrogenation reaction system according to a fourth example.

FIG. 7 shows an example of an operation of the dehydrogenation reaction system according to the fourth example.

FIG. 8 shows an example computing system (e.g., a computing device of a fuel cell system or any other apparatus).

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION

The terminology used herein is for the purpose of describing particular examples only and is not intended to be limiting of the present disclosure. As used herein, the singular forms “a,” “an,” and “the” are intended to include the plural forms as well, unless the context clearly indicates otherwise. The terms “include” and/or “including” and “comprise” and/or “comprising” specify the presence of the mentioned characteristics, integers, steps, operations, constituent elements, and/or components when used in the present specification, but it will also be understood that this does not exclude the presence or addition of one or more of other characteristics, integers, steps, operations, constituent elements, components, and/or groups thereof. As used herein, the term “and/or” includes any one or all combinations of the associated and listed items.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

In addition, it is understood that one or more of the methods below or the aspects thereof may be executed by at least one or more controllers. The term “controller” may refer to a hardware device including a memory and a processor. The memory is configured to store program commands, and the processor is specially programmed so as to execute program commands to perform one or more processes described in more detail below. The controller may control operations of units, modules, components, devices, or similar matters thereof as described herein. Further, it is understood that the following methods may be executed by a device including a controller together with one or more other components as recognized by those skilled in the art.

Further, the controller of the present disclosure may be implemented as a non-transitory computer readable recording medium including program commands executable by a processor. Examples of the computer readable recording medium includes a read only memory (ROM), a random access memory (RAM), a compact disc (CD) ROM, magnetic tapes, floppy discs, flash drives, smart cards, and optical data storage devices, but the computer readable recording medium is not limited thereto. The computer readable recording medium may also be dispersed across the computer network to store and execute program commands by a distributed method, such as a telematics server or a controller arear network (CAN).

The present disclosure will be described more fully hereinafter with reference to the accompanying drawings, in which examples of the disclosure are shown. However, as those skilled in the art would realize, the described examples may be modified in various different ways, all without departing from the spirit or scope of the only and present disclosure.

In order to clearly describe the present disclosure, parts or portions that are irrelevant to the description are omitted, and identical or similar constituent elements throughout the specification are denoted by the same reference numerals.

In addition, since the size and thickness of each configuration shown in the drawings are arbitrarily shown for convenience of description, the present disclosure is not necessarily limited to configurations illustrated in the drawings, and in order to clearly illustrate several parts and areas, enlarged thicknesses are shown.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

In addition, in describing examples, when it is determined that a detailed description of the well-known art associated with the present disclosure may obscure the gist of the present disclosure, it will be omitted.

In addition, the accompanying drawings are provided only in order to allow examples disclosed in the present specification to be easily understood and are not to be interpreted as limiting the spirit disclosed in the present specification, and it is to be understood that the present disclosure includes all modifications, equivalents, and substitutions without departing from the scope and spirit of the present disclosure.

Terms including an ordinal number, such as first, second, etc., may be used to describe various elements, but the elements are not limited by the terms.

In the description below, a singular form may be intended to include a plural form as well, unless an explicit expression such as “one” or “single” is used.

These terms are only used to differentiate one constituent element from another.

In the flowcharts described with reference to the drawings in this specification, the operation order may be changed, various operations may be merged, certain operations may be divided, and certain operations may not be performed.

Hereinafter, a dehydrogenation reaction system according to a first example will be described in detail with reference to the accompanying drawings.

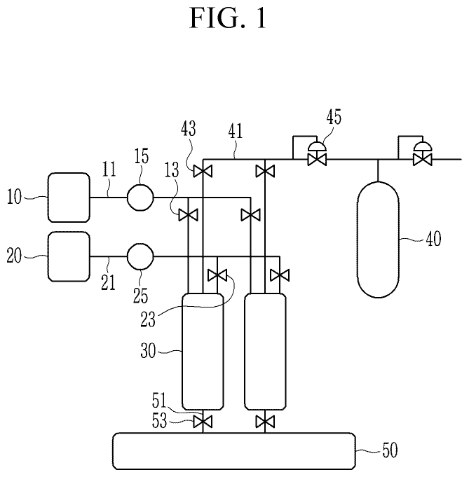

FIG. 1 shows an example of a dehydrogenation reaction system according to a first example.

As shown in FIG. 1, the dehydrogenation reaction system according to the first example may include an acid aqueous solution tank 10, a chemical hydride tank 20, a dehydrogenation reactor 30, a hydrogen tank 40, and a product tank.

The acid aqueous solution tank 10 stores an acid aqueous solution, and the stored acid aqueous solution may be selectively supplied to the dehydrogenation reactor 30 (e.g., during a startup sequence, a controlled injection cycle, or a pH adjustment stage, etc.). To this end, an acid aqueous solution valve 13 is provided in an acid aqueous solution supply line 11 that fluidly connects an acid aqueous solution tank 10 and the dehydrogenation reactor 30, and the acid solution may be supplied to the dehydrogenation reactor 30 according to the opening and closing of the acid aqueous solution valve 13 (e.g., a solenoid valve, a needle valve, or a motorized ball valve, etc.). In addition, an acid aqueous solution pump 15 is provided in the acid aqueous solution supply line 11, and the acid aqueous solution stored in the acid aqueous solution tank 10 may be pumped through the acid aqueous solution pump 15 and supplied to the dehydrogenation reactor 30. For example, the pump 15 may be a peristaltic pump, a diaphragm pump, or a gear pump, etc., depending on the required flow rate, chemical compatibility, and system pressure conditions.

The acid aqueous solution tank may be provided with a corrosion-resistant protective film, such as a Teflon coating, to prevent corrosion caused by the acid aqueous solution. Other suitable protective coatings may include, for example, glass lining, fluoropolymer layers, epoxy resins, or ceramic coatings, etc. The aqueous acid solution promotes the dehydrogenation reaction by adjusting the pH of the chemical hydride to shorten its half-life (e.g., by accelerating hydrolysis, enhancing proton transfer, or increasing the reaction rate of hydride decomposition, etc.).

The acid applied to the acid aqueous solution may be an inorganic acid such as sulfuric acid, nitric acid, phosphoric acid, boric acid, or hydrochloric acid, an organic acid such as heteropoly acid, acetic acid, formic acid, malic acid, citric acid, tartaric acid, ascorbic acid, lactic acid, oxalic acid, succinic acid, or tauric acid, or a mixture thereof (e.g., a blend of citric acid and phosphoric acid, or a combination of lactic acid and nitric acid, etc.), and formic acid (HCOOH) may be used because it has a small molecular weight compared to hydrogen ions, which may reduce the weight of the system, and is considered to be safer than hydrochloric acid at high concentrations.

In the case of formic acid, it is a weak acid and may be used relatively safely because it is maintained at a low pH under set conditions. In addition, since the captured carbon dioxide may be obtained through hydrogenation, it is an important material in terms of re-utilizing/recycling of carbon dioxide (e.g., carbon cycle management, energy carrier reuse, or low-carbon fuel synthesis, etc.). In addition, formate is converted to bicarbonate through a dehydrogenation reaction, in which case hydrogen may be additionally obtained.

The chemical hydride tank 20 stores a liquid chemical hydride, and the stored chemical hydride may be selectively supplied to the dehydrogenation reactor 30 (e.g., in response to hydrogen demand, system pressure drop, or timed injection control, etc.). To this end, a hydride valve 23 may be provided in a hydride supply line 21 that fluidly connects the chemical hydride tank 20 and the dehydrogenation reactor 30, and chemical hydride may be supplied to the dehydrogenation reactor 30 according to the opening and closing of the hydride valve 23 (e.g., a check valve, a pinch valve, or an electronically actuated valve, etc.). In addition, a hydride pump 25 is provided in the hydride supply line 21, and the chemical hydride stored in the chemical hydride tank 20 may be pumped through the hydride pump 25 and supplied to the dehydrogenation reactor 30. Examples of chemical hydrides may include sodium borohydride (NaBH₄), lithium borohydride (LiBH₄), potassium borohydride (KBH₄), or ammonia borane (NH₃BH₃), etc., which may be stored in liquid form for easier handling and safer injection into the reactor. The liquid phase storage and injection of both the acid aqueous solution and the chemical hydride eliminate the need to directly handle solid materials (e.g., powdered sodium borohydride or granulated citric acid), thereby improving operational safety, automating the injection process, and minimizing exposure-related risks.

The chemical hydride may be in the form of an aqueous solution dissolved in water. If necessary, the chemical hydride reaction may be delayed by increasing the pH by adding an alkaline material to the water (e.g., NaOH, NaBO2, KOH, LiOH, CsOH, etc.). The chemical hydride is an aqueous solution and may be composed of approximately 10 to 25 wt % of chemical hydride, 1 to 10 wt % of alkaline material, and the remainder of 65 to 89 wt % of water (e.g., deionized water or distilled water, etc.).

The dehydrogenation reactor 30 may produce hydrogen gas by a chemical reaction between a chemical hydride and an acid aqueous solution.

The dehydrogenation reactor 30 may be configured as a high-temperature and high-pressure vessel so that the dehydrogenation reaction may be performed under elevated temperature and pressure conditions (e.g., temperatures of 60° C. to 120° C. and pressures of 10 to 1000 bar, depending on the desired reaction rate and storage requirements, etc.). For example, the dehydrogenation reactor 30 may have a cylindrical, spherical, rectangular parallelepiped, or polygonal prism shape, and particularly, may have a cylindrical shape (e.g., vertically oriented or horizontally mounted, depending on installation constraints or flow dynamics, etc.).

High-pressure hydrogen gas generated in the dehydrogenation reactor 30 may be selectively stored in the hydrogen tank 40 (e.g., a Type III or Type IV composite tank designed for storage pressures exceeding 350 bar, etc.). To this end, a hydrogen back pressure regulator 45 may be provided in a hydrogen discharge line 41 that fluidly connects the dehydrogenation reactor 30 to the hydrogen tank 40, and a hydrogen valve 43 may be provided upstream of the hydrogen back pressure regulator 45 (e.g., to enable selective control of hydrogen flow during pressurized charging, purging, or safety shutdown operations, etc.). According to the opening and closing of the hydrogen valve 43, the high-pressure hydrogen gas generated in the dehydrogenation reactor 30 may be supplied to the hydrogen tank 40. For example, the hydrogen valve 43 may be a solenoid valve, needle valve, or ball valve, etc., selected based on desired response time and pressure rating. The high-pressure hydrogen gas stored in the hydrogen tank 40 may be supplied to a high-pressure charging target 60 (e.g., a hydrogen-powered vehicle, stationary fuel cell, or portable hydrogen cartridge, etc.).

In order to stably extract hydrogen from the dehydrogenation reactor 30, it is necessary to increase the internal pressure of the reaction vessel of the dehydrogenation reactor 30 to a specific pressure (e.g., approximately 500 bar) to control the boiling point of the reactant (e.g., within a range of 100° C. to 400° C.) to reduce or minimize the phase change of the reactant (e.g., from liquid to gas or from liquid to solid, etc.). To this end, the internal pressure of the reaction vessel of the dehydrogenation reactor 30 may be controlled by installing the hydrogen back pressure regulator 45 downstream of the dehydrogenation reactor 30 (e.g., along the hydrogen discharge line leading to the hydrogen tank, buffer tank, or pressure relief system, etc.).

The product produced by the dehydrogenation reaction in the dehydrogenation reactor 30 may be stored in a product tank 50 (e.g., a sealed container made of acid-and heat-resistant material such as stainless steel, glass-lined steel, or polymer composites, etc.). To this end, a product valve 53 is provided in a product discharge line 51 that fluidly connects the dehydrogenation reactor 30 and the product tank 50, and the product of the dehydrogenation reactor 30 may be discharged to the product tank 50 according to the opening and closing of the product valve 53 (e.g., a corrosion-resistant solenoid valve, diaphragm valve, or pinch valve, etc.).

For example, when the chemical hydride is NaBH4 and the acid is HCOOH, a dehydrogenation reaction occurs as shown in Reaction Formula 1 below.

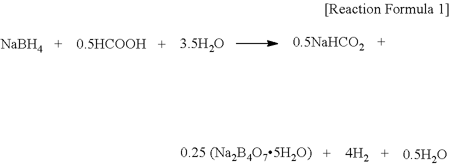

For example, the product may be NaHCO₂, Na₂B₄O₇·5H₂O, H₂O, and the like generated by the dehydrogenation reaction.

The dehydrogenation reaction system according to the first example may include a controller 80 that supplies an acid aqueous solution or water so that the product has a set volume within the dehydrogenation reactor 30 while the hydrogen gas maintains the target pressure, before discharging the product. This ensures that the pressure of the dehydrogenation reactor 30 maintains a reference pressure when the dehydrogenation reaction is completed in the dehydrogenation reactor 30 and all the products generated in the dehydrogenation reactor 30 are discharged. The control 80 may then discharge the product of the dehydrogenation reactor 30 into the product tank 50 (e.g., by activating a pump or valve sequence based on measured internal pressure, temperature, or volume levels, etc.).

In other words, the controller 80 may control the volume of the product in the dehydrogenation reactor 30 by supplying an acid aqueous solution or water while the hydrogen gas maintains the target pressure, before discharging the product, so that the pressure of the dehydrogenation reactor 30 maintains the reference pressure when all the products generated in the dehydrogenation reactor 30 are discharged (e.g., by dynamically adjusting fluid injection or venting operations based on sensor feedback such as pressure transducers or level indicators, etc.). Thereafter, the product may be discharged from the dehydrogenation reactor 30.

To this end, the controller 80 may control the operation of the acid aqueous solution valve 13, the acid aqueous solution pump 15, the hydride valve 23, the hydride pump 25, the hydrogen valve 43, and the product valve 53 (e.g., by issuing timed control signals, receiving sensor inputs, or executing feedback loops, etc.).

The controller 80 may be implemented with one or more processors that operate according to a set program, and the memory of the controller 80 stores program instructions configured to perform each step of the control method of the dehydrogenation reaction system according to the present disclosure through one or more processors (e.g., microcontrollers, industrial PCs, or embedded control boards, etc.).

Hereinafter, a control method of the dehydrogenation reaction system according to the first example will be described in detail with reference to the accompanying drawings.

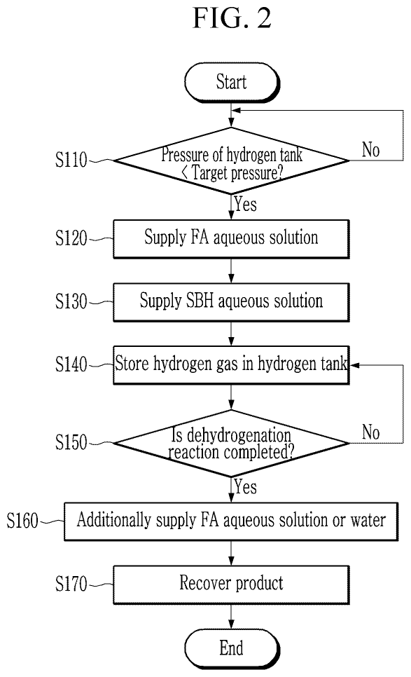

FIG. 2 shows an example of an operation of the dehydrogenation reaction system according to the first example.

Referring to FIG. 2, the controller 80 may determine whether the pressure of the hydrogen tank 40 is less than the target pressure (e.g., 500 bar) (S110).

If the pressure of the hydrogen tank 40 exceeds the target pressure, the controller 80 blocks the acid aqueous solution valve 13, the hydride valve 23, and the hydrogen valve 43, and does not supply the acid aqueous solution and the chemical hydride to the dehydrogenation reactor 30 (e.g., to prevent over-pressurization, ensure system safety, and avoid unnecessary reactant consumption, etc.).

If the pressure of the hydrogen tank 40 is less than the target pressure, the controller 80 may supply a set amount of acid aqueous solution (e.g., approximately 303 mL) to the dehydrogenation reactor 30 (S120). To this end, the controller 80 may open the acid aqueous solution valve 13 and operate the acid aqueous solution pump 15 to supply the acid aqueous solution stored in the acid aqueous solution tank 10 to the dehydrogenation reactor 30 (e.g., at a controlled flow rate for precise volume delivery, depending on reaction stage or system temperature, etc.).

In addition, the controller 80 may supply a set amount of chemical hydride (e.g., approximately 1,227 mL) to the dehydrogenation reactor 30 (S130). To this end, the controller 80 may open the hydride valve 23 and operate the hydride pump 25 to supply the chemical hydride stored in the chemical hydride tank 20 to the dehydrogenation reactor 30 (e.g., under controlled flow conditions to maintain stoichiometric balance with the acid aqueous solution, etc.).

When the acid aqueous solution and the chemical hydride are supplied to the dehydrogenation reactor 30, a dehydrogenation reaction occurs in the dehydrogenation reactor 30, and hydrogen gas and products may be generated (e.g., hydrogen gas and a liquid byproduct such as a borate solution, etc.). The hydrogen gas generated in the dehydrogenation reactor 30 may be stored in the hydrogen tank 40 (S140) (e.g., by pressurizing the hydrogen line and regulating flow with a back pressure regulator, etc.). In this case, the controller 80 opens the hydrogen valve 43 so that the high-pressure hydrogen gas (e.g., approximately 500 bar) generated in the dehydrogenation reactor 30 may be supplied to the hydrogen tank 40 (e.g., using a pressurized discharge line monitored by pressure sensors or flow meters, etc.).

The controller 80 determines whether the dehydrogenation reaction is completed (S150) and may supply the hydrogen gas of the dehydrogenation reactor 30 to the hydrogen tank 40 until the dehydrogenation reaction is completed. In this case, if a predetermined time has elapsed, the controller 80 may determine that the dehydrogenation reaction has been completed (e.g., based on a reaction timer, pressure stabilization, or cessation of gas generation detected by flow or pressure sensors, etc.).

When the dehydrogenation reaction is completed, the controller 80 may additionally supply a set amount of acid aqueous solution or water (e.g., approximately 464 mL) to the dehydrogenation reactor 30 (S160). To this end, the controller 80 may open the acid aqueous solution valve 13 and operate the acid aqueous solution pump 15 to additionally supply a set amount of the acid aqueous solution to the dehydrogenation reactor 30 (e.g., to stabilize pressure and aid in displacing residual gases or byproducts, etc.). For example, when the product of the dehydrogenation reactor 30 is completely discharged, the controller 80 may additionally supply an acid aqueous solution or water to the dehydrogenation reactor 30 so that the pressure of the dehydrogenation reactor 30 is maintained at the reference pressure (e.g., to prevent backflow, allow safe venting, or facilitate complete transfer of remaining product, etc.). Through this, the product and the hydrogen gas may have a set volume within the dehydrogenation reactor 30 while the hydrogen gas maintains the target pressure before discharging the product (e.g., to ensure pressure equilibrium, avoid hydrogen loss, and enable safe and complete transfer of the byproduct, etc.).

The controller 80 may discharge the product generated in the dehydrogenation reactor 30 into the product tank 50. To this end, the controller 80 may open the product valve 53 to discharge the product of the dehydrogenation reactor 30 into the product tank 50 (e.g., by activating a timed release or pressure-driven purge cycle, etc.).

In the first example, the pressure (target pressure) of the hydrogen gas stored in the hydrogen tank 40 may be approximately 500 bar, the acid aqueous solution supplied to the dehydrogenation reactor 30 may be about 303 mL, the chemical hydride supplied to the dehydrogenation reactor 30 may be about 1,227 mL, the internal volume of the dehydrogenation reactor 30 may be approximately 2 L, and the additionally supplied acid aqueous solution may be about 464 mL (e.g., to maintain target pressure and assist in flushing residual byproducts, etc.).

The chemical hydride in the form of an aqueous solution may be composed of approximately 10 to 25 wt % of the chemical hydride, 1 to 10 wt % of an alkaline material, and 65 to 89 wt % of water (e.g., deionized or distilled water, etc.), and the acid aqueous solution may have a composition of 25 to 75 wt % of formic acid (FA), and the remainder being H₂O (e.g., to optimize reactivity while maintaining safe handling characteristics, etc.).

In order to quickly discharge the product inside the dehydrogenation reactor 30, when all the products are discharged from the dehydrogenation reactor 30 (e.g., to ensure smooth flow through the discharge line and prevent vacuum formation or backflow, etc.), the pressure of the dehydrogenation reactor 30 may be maintained at the reference pressure (e.g.,, approximately 1.1 to 1.5 bar).

If the pressure of the dehydrogenation reactor 30 is lower than the reference pressure, the discharge speed of the product may be slow because the discharge of the product is only by gravity (e.g., leading to incomplete or delayed evacuation of the reactor contents, etc.). On the other hand, if the pressure of the dehydrogenation reactor 30 is higher than the reference pressure, not only the product but also hydrogen gas may be discharged due to excessive pressure (e.g., through unintended venting or product line backflow, etc.). Accordingly, this may result in loss of hydrogen gas (e.g., reducing system efficiency or compromising safety margins, etc.).

Therefore, in order to maintain the pressure of hydrogen gas in the dehydrogenation reactor 30 (with an internal volume of 2 L) at the reference pressure (e.g., 1.5 bar) when all the products are discharged, the volume of hydrogen gas should be approximately 6 mL and the volume of the products should be approximately 1,994 mL while the pressure of hydrogen gas is maintained at the target pressure (e.g., 1.5 bar) before discharging the products (e.g., to ensure controlled flow and reduce hydrogen loss, etc.).

To this end, in the first example, approximately 303 mL of an acid aqueous solution and 1,227 mL of a chemical hydride are first supplied to the dehydrogenation reactor 30, and when the dehydrogenation reaction is completed, an additional 464 mL of an acid aqueous solution or water that is not involved in the dehydrogenation reaction is supplied. Accordingly, when the product is discharged from the dehydrogenation reactor 30, an acid aqueous solution or water may be additionally supplied so that the product reaches a set volume ratio (e.g., 2,000:1,994) within the dehydrogenation reactor 30 (e.g., ensuring that only a minimal volume of hydrogen gas remains to maintain reference pressure without discharging excess gas, etc.). Thereafter, the product may be discharged from the dehydrogenation reactor 30.

For example, when the internal volume of the dehydrogenation reactor 30 is 2 L, the pressure P1 (target pressure) of the hydrogen gas of the dehydrogenation reactor 30 before discharging the product is approximately 500 bar, and the volume V1 of the hydrogen gas is approximately 6 mL (e.g., or, the volume of the product is about 1994 mL). Therefore, after all the products are discharged, the volume V2 of the dehydrogenation reactor 30 is 2000 mL, so the dehydrogenation reactor 30 may maintain a reference pressure P2 of approximately 1.5 bar (e.g., by gas expansion from V₁ to V₂ under ideal gas assumptions, etc.).

Hereinafter, a dehydrogenation reaction system according to a second example will be described in detail with reference to the accompanying drawings.

The configuration of the dehydrogenation reaction system according to the second example is substantially the same as that of the dehydrogenation reaction system according to the first example.

However, in the second example, at least two dehydrogenation reactors 30 may be provided, and the controller 80 may control the pressure of one dehydrogenation reactor 30 to maintain a reference pressure when the dehydrogenation reaction is completed in one dehydrogenation reactor 30 and the product generated in the dehydrogenation reactor 30 is discharged to the product tank 50 (e.g., to ensure stable product flow, prevent hydrogen loss, and prepare the reactor for the next cycle, etc.), and may control the hydrogen gas of one dehydrogenation reactor 30 to be discharged to another dehydrogenation reactor 30 while maintaining a set volume ratio of the product and hydrogen gas before discharging the product so that the hydrogen gas reaches a set pressure (e.g., enabling pressure equalization or pressure-assisted purging of product, etc.). Thereafter, the product of the dehydrogenation reactor 30 may be discharged to the product tank 50 (e.g., once target pressure is achieved to ensure efficient product flow and hydrogen retention, etc.).

In other words, in the second example, a set amount of acid aqueous solution and a set amount of chemical hydride are supplied to the dehydrogenation reactor 30, and after the dehydrogenation reaction is completed in the dehydrogenation reactor 30, a portion of the hydrogen gas in the dehydrogenation reactor 30 may be discharged to another dehydrogenation reactor 30 (e.g., one that has just completed its own product discharge cycle and is ready to begin a new reaction, etc.). Through this, when discharging the product from the dehydrogenation reactor 30, the hydrogen gas may be controlled to reach a set pressure before discharging the product, and then the product may be discharged (e.g., ensuring optimal pressure balance for efficient product evacuation and minimal hydrogen loss, etc.).

Hereinafter, a control method of the dehydrogenation reaction system according to the second example will be described in detail with reference to the accompanying drawings.

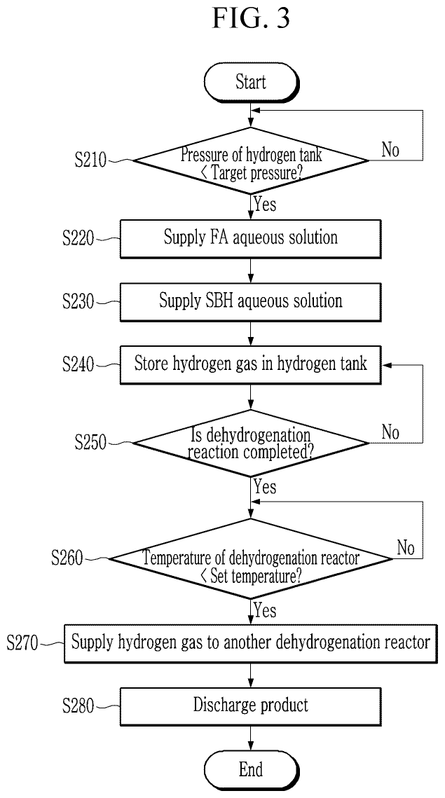

FIG. 3 shows an example of an operation of a dehydrogenation reaction system according to a second example.

Referring to FIG. 3, the controller 80 may determine whether the pressure of the hydrogen tank 40 is less than the target pressure (e.g., 875 bar) (S210).

If the pressure of the hydrogen tank 40 exceeds the target pressure, the controller 80 blocks the acid aqueous solution valve 13, the hydride valve 23, and the hydrogen valve 43, and does not supply the acid aqueous solution and the chemical hydride to the dehydrogenation reactor 30 (e.g., to prevent over pressurization, ensure operational safety, and avoid unnecessary reactant use, etc.).

If the pressure of the hydrogen tank 40 is lower than the target pressure, the controller 80 may supply a set amount of the acid aqueous solution (e.g., approximately 379 mL) to the dehydrogenation reactor 30 (S220). To this end, the controller 80 may open the acid aqueous solution valve 13 and operate the acid aqueous solution pump 15 to supply the acid aqueous solution stored in the acid aqueous solution tank 10 to the dehydrogenation reactor 30 (e.g., at a controlled rate to initiate the dehydrogenation reaction while avoiding pressure spikes, etc.).

The controller 80 may supply a set amount of chemical hydride (e.g., approximately 1,536 mL) to the dehydrogenation reactor 30 (S230). To this end, the controller 80 may open the hydride valve 23 and operate the hydride pump 25 to supply the chemical hydride stored in the chemical hydride tank 20 to the dehydrogenation reactor 30 (e.g., in proportion to the acid aqueous solution to ensure optimal reaction conditions and hydrogen yield, etc.).

When the acid aqueous solution and the chemical hydride are supplied to the dehydrogenation reactor 30, a dehydrogenation reaction occurs in the dehydrogenation reactor 30, and hydrogen gas and products may be generated (e.g., depending on the concentration and reactivity of the supplied materials, etc.). The hydrogen gas generated in the dehydrogenation reactor 30 may be stored in the hydrogen tank 40 (S240) (e.g., via a high-pressure line regulated by a back pressure valve to maintain safe and efficient transfer, etc.). In this case, the controller 80 opens the hydrogen valve 43 so that the high-pressure hydrogen gas (e.g., approximately 875 bar) generated in the dehydrogenation reactor 30 may be supplied to the hydrogen tank 40.

The controller 80 determines whether the dehydrogenation reaction is completed (S250) and may supply the hydrogen gas of the dehydrogenation reactor 30 to the hydrogen tank 40 until the dehydrogenation reaction is completed. In this case, if a predetermined time has elapsed, the controller 80 may determine that the dehydrogenation reaction has been completed (e.g., based on a timer, gas flow rate drop, or sensor signal, etc.).

When the dehydrogenation reaction is complete, the controller 80 may determine whether the temperature of the dehydrogenation reactor 30 is less than a set temperature (e.g., 80 degrees Celsius) (S260) (e.g., to ensure safe handling and discharge of the reaction products, etc.).

If the temperature of the dehydrogenation reactor 30 is less than the set temperature, the controller 80 may discharge hydrogen gas from the dehydrogenation reactor 30 to another dehydrogenation reactor 30 (S270). To this end, the controller 80 opens the hydrogen valve 43 downstream of the dehydrogenation reactor 30 and the hydrogen valve 43 of the other dehydrogenation reactor 30, so that the hydrogen gas of one dehydrogenation reactor 30 may be discharged to another dehydrogenation reactor 30 (e.g., to assist in pressurizing the second reactor for the next product discharge cycle, etc.). In this case, the pressure of one dehydrogenation reactor 30 may be lowered to 35 bar. If the temperature of the dehydrogenation reactor 30 is higher than the set temperature (e.g., 80 degrees Celsius), discharging hydrogen gas from one dehydrogenation reactor 30 to another dehydrogenation reactor 30 may cause the product to boil over due to the rapid pressure decrease (e.g., resulting in foaming, splashing, or uncontrolled discharge, etc.). Therefore, hydrogen gas may be discharged from one dehydrogenation reactor 30 to another dehydrogenation reactor 30 if the temperature of the dehydrogenation reactor 30 is lower than the set temperature (e.g., to ensure safe and stable pressure equalization between reactors, etc.). For example, when the dehydrogenation reaction is completed, in order to maintain the pressure of the dehydrogenation reactor 30 at the reference pressure when all the products of the dehydrogenation reactor 30 are discharged, the controller 80 may discharge the hydrogen gas of one dehydrogenation reactor 30 to another dehydrogenation reactor 30 while the products and hydrogen gas are maintained at the set volume ratio (e.g., to ensure the proper pressure balance between gaseous and liquid contents, etc.). Through this, the pressure of the dehydrogenation reactor 30 may reach the set pressure before discharging the product (e.g., allowing efficient product evacuation without hydrogen loss or pressure shock, etc.).

The controller 80 may discharge the product generated from one dehydrogenation reactor 30 into the product tank 50 (S280). To this end, the controller 80 may block all the hydrogen valves 43 and open the product valve 53 to discharge the product from the dehydrogenation reactor 30 into the product tank 50 (e.g., ensuring that hydrogen is retained while the liquid product is safely evacuated, etc.).

In the second example, the pressure (target pressure) of the hydrogen gas stored in the hydrogen tank 40 may be approximately 875 bar, the acid aqueous solution supplied to the dehydrogenation reactor 30 may be approximately 379 mL, the chemical hydride supplied to the dehydrogenation reactor 30 may be approximately 1,536 mL, and the internal volume of the dehydrogenation reactor 30 may be 2 L.

The chemical hydride may be in the form of an aqueous solution dissolved in water. If necessary, the chemical hydride reaction may be delayed by increasing the pH by adding an alkaline material to the water (e.g., NaOH, NaBO2, KOH, LiOH, CsOH, etc.). The chemical hydride is an aqueous solution and may be composed of 10 to 25 wt % of chemical hydride, 1 to 10 wt % of alkaline material, and the remainder of 65 to 89 wt % of water (e.g., to balance reactivity, stability, and solubility, etc.).

As described in the first example, in order to quickly discharge the product inside the dehydrogenation reactor 30, when all the products are discharged from the dehydrogenation reactor 30, the pressure of the dehydrogenation reactor 30 may be maintained at the reference pressure (e.g., 1.1 to 1.5 bar).

Therefore, in order to maintain the pressure of hydrogen gas in the dehydrogenation reactor 30 (with an internal volume of 2 L) at the reference pressure (e.g., 1.5 bar) when all the products are discharged, the volume of hydrogen gas should be about 85 mL and the volume of the products should be 1,915 mL while the pressure of hydrogen gas is maintained at the set pressure (e.g., 35 bar) before discharging the products.

To this end, in the second example, 379 mL of an acid aqueous solution and 1,536 mL of a chemical hydride are supplied to the dehydrogenation reactor 30, and when the dehydrogenation reaction is completed, the hydrogen gas of the dehydrogenation reactor 30 may be discharged to another dehydrogenation reactor 30 (e.g., to reduce the internal pressure while preserving system efficiency, etc.). Accordingly, the pressure of the dehydrogenation reactor 30 where the dehydrogenation reaction is completed may be lowered to the set pressure (e.g., 35 bar). Thereafter, the product may be discharged from the dehydrogenation reactor 30 (e.g., under controlled pressure to avoid gas loss and enable efficient transfer, etc.).

For example, when the internal volume of the dehydrogenation reactor 30 is 2 L, the pressure P1 (set pressure) of the dehydrogenation reactor 30 before discharging the product is approximately 35 bar, and the volume of hydrogen gas is about 85 mL. Therefore, after all the products are discharged, the volume V2 of the dehydrogenation reactor 30 is 2000 mL, so the dehydrogenation reactor 30 may maintain a reference pressure P2 of approximately 1.5 bar (e.g., ensuring proper product discharge while preserving residual hydrogen for system balance, etc.).

Hereinafter, a dehydrogenation reaction system according to a third example will be described in detail with reference to the accompanying drawings.

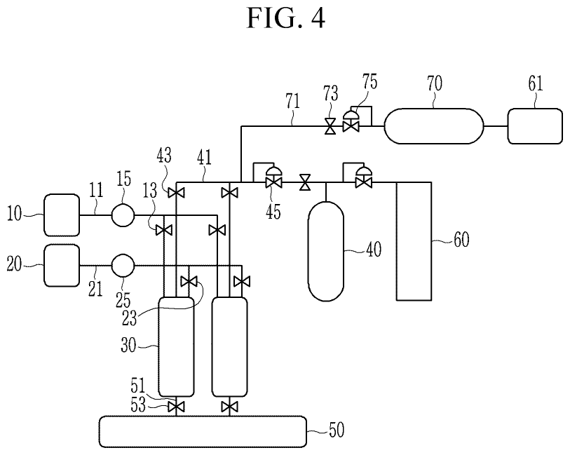

FIG. 4 shows an example of the dehydrogenation reaction system according to the third example.

The dehydrogenation reaction system shown in FIG. 4 is substantially similar to the dehydrogenation reaction system shown in FIG. 1. Hereinafter, a description will be provided focusing on the differences from the dehydrogenation reaction system of FIG. 1.

The dehydrogenation reaction system according to the third example may include a buffer tank 70 that selectively stores low-pressure hydrogen gas generated in the dehydrogenation reactor 30. To this end, a buffer valve 73 is provided in a buffer discharge line 71 that fluidly connects the dehydrogenation reactor 30 and the buffer tank 70, and hydrogen gas from the dehydrogenation reactor 30 may be supplied to the buffer tank 70 according to the opening and closing of the buffer valve 73. The low-pressure hydrogen gas stored in the buffer tank 70 may be supplied to a low-pressure charging target 61 (e.g., a small battery or a small fuel cell, a portable power supply, a micro fuel cell, or the like, etc.).

If necessary, a buffer back pressure regulator 75 may be provided between the buffer valve 73 and the buffer tank 70. By providing the buffer back pressure regulator 75 upstream of the buffer tank 70, the internal pressure of the buffer tank 70 may be controlled (e.g., to maintain stable pressure suitable for downstream applications or devices, etc.).

The controller 80 of the dehydrogenation reaction system according to the third example, so that when the dehydrogenation reaction is completed in the dehydrogenation reactor 30 and all the products generated in the dehydrogenation reactor 30 are discharged, may maintain the pressure of the dehydrogenation reactor 30 at a reference pressure. The controller 80 may discharge the hydrogen gas from the dehydrogenation reactor 30 to the buffer tank 70 so that the hydrogen gas reaches the set pressure while the product and hydrogen gas are maintained at a set volume ratio before discharging the product, and then may discharge the product of the dehydrogenation reactor 30 to the product tank 50 (e.g., enabling pressure-controlled product evacuation while preserving hydrogen for secondary use, etc.).

In other words, in the third example, a set amount of acid aqueous solution and a set amount of chemical hydride are supplied to the dehydrogenation reactor 30, and after the dehydrogenation reaction is completed, a portion of the hydrogen gas in the dehydrogenation reactor 30 may be discharged to the buffer tank 70. Through this, when discharging the product from the dehydrogenation reactor 30, the hydrogen gas may be adjusted to reach the set pressure before discharging the product. Thereafter, the product may be discharged (e.g., ensuring stable product flow without hydrogen loss or pressure imbalance, etc.).

Hereinafter, a control method of the dehydrogenation reaction system according to the third example will be described in detail with reference to the accompanying drawings.

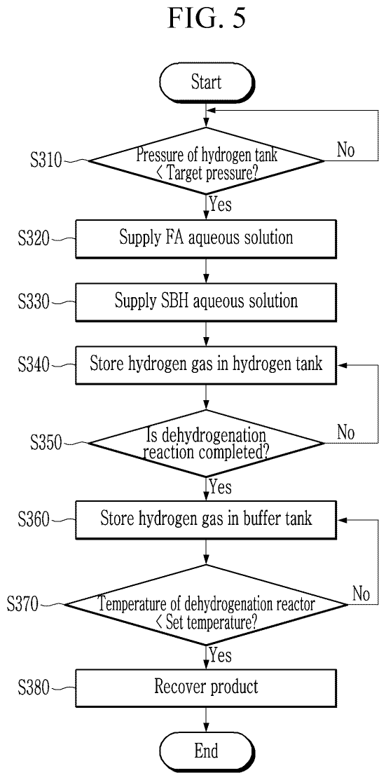

FIG. 5 shows an example of an operation of the dehydrogenation reaction system according to the third example.

Referring to FIG. 5, the controller 80 may determine whether the pressure of the hydrogen tank 40 is less than the target pressure (e.g., 875 bar) (S310).

If the pressure of the hydrogen tank 40 is higher than the target pressure, the controller 80 may block the acid aqueous solution valve 13, the hydride valve 23, and the hydrogen valve 43, and does not supply the acid aqueous solution and the chemical hydride to the dehydrogenation reactor 30.

If the pressure of the hydrogen tank 40 is lower than the target pressure, the controller 80 may supply a set amount of the acid aqueous solution (e.g., 340 mL) to the dehydrogenation reactor 30 (S320). To this end, the controller 80 may open the acid aqueous solution valve 13 and operate the acid aqueous solution pump 15 to supply the acid aqueous solution stored in the acid aqueous solution tank 10 to the dehydrogenation reactor 30 (e.g., to initiate or facilitate the dehydrogenation reaction by adjusting pH and reaction conditions, etc.).

The controller 80 may supply a set amount of chemical hydride (e.g., 1,374 mL) to the dehydrogenation reactor 30 (S330). To this end, the controller 80 may open the hydride valve 23 and operate the hydride pump 25 to supply the chemical hydride stored in the chemical hydride tank 20 to the dehydrogenation reactor 30 (e.g., initiating the hydrogen-generating reaction process, etc.).

When the acid aqueous solution and the chemical hydride are supplied to the dehydrogenation reactor 30, a dehydrogenation reaction occurs in the dehydrogenation reactor 30, and hydrogen gas and products (e.g., formate derivatives, bicarbonates, or byproducts of neutralization, etc.) may be generated. The hydrogen gas generated in the dehydrogenation reactor 30 may be stored in the hydrogen tank 40 (S340). In this case, the controller 80 may open the hydrogen valve 43 so that the high-pressure hydrogen gas (e.g., 875 bar) generated in the dehydrogenation reactor 30 may be supplied to the hydrogen tank 40.

The controller 80 may determine whether the dehydrogenation reaction is completed (S350) and may supply the hydrogen gas of the dehydrogenation reactor 30 to the hydrogen tank 40 until the dehydrogenation reaction is completed (e.g., using a preset reaction time threshold, etc.). In this case, if a predetermined time has elapsed, the controller 80 may determine that the dehydrogenation reaction has been completed.

When the dehydrogenation reaction is completed, the controller 80 may discharge the hydrogen gas remaining in the dehydrogenation reactor 30 into the buffer tank 70 (S360). To this end, the controller 80 may open the buffer valve 73 to discharge the hydrogen gas from the dehydrogenation reactor 30 into the buffer tank 70 (e.g., for temporary storage, redistribution to a low-pressure application, or pressure balancing, etc.). In this case, the internal pressure of the buffer tank 70 may be controlled through the buffer back pressure regulator 75 (e.g., to maintain safe and consistent pressure levels for downstream use in low-pressure devices, etc.). For example, when the dehydrogenation reaction is completed, in order to maintain the pressure of the dehydrogenation reactor 30 at the reference pressure when all the products of the dehydrogenation reactor 30 are discharged, the controller 80 may discharge the hydrogen gas from the dehydrogenation reactor 30 to the buffer tank 70 while the products and hydrogen gas maintain the preset volume ratio (e.g., approximately 1,915 mL of product to 85 mL of hydrogen gas, etc.). Through this, the pressure of the dehydrogenation reactor 30 may reach the set pressure (e.g., 1.5 bar) before discharging the product.

The controller 80 may determine whether the pressure of the dehydrogenation reactor 30 is less than the set pressure (for example, 10.5 bar) (S370).

If the pressure of the dehydrogenation reactor 30 is less than the reference pressure, the controller 80 may discharge the product generated in the dehydrogenation reactor 30 into the product tank 50 (S380). To this end, the controller 80 may block all the hydrogen valves 43 and open the product valve 53 to discharge the product (e.g., a mixture of reaction residues, bicarbonate compounds, or dissolved salts, etc.) of the dehydrogenation reactor 30 into the product tank 50.

In the third example, the pressure (target pressure) of the hydrogen gas stored in the hydrogen tank 40 may be about 875 bar, the acid aqueous solution supplied to the dehydrogenation reactor 30 may be approximately 340 mL, the chemical hydride supplied to the dehydrogenation reactor 30 may be approximately 1,374 mL, and the internal volume of the dehydrogenation reactor 30 may be 2 L.

The chemical hydride may be in the form of an aqueous solution dissolved in water. If necessary, the chemical hydride reaction may be delayed by increasing the pH by adding an alkaline material to the water (e.g., NaOH, NaBO2, KOH, LiOH, CsOH, etc.). The chemical hydride is an aqueous solution and may be composed of 10 to 25 wt % of chemical hydride, 1 to 10 wt % of alkaline material, and the remainder (e.g., 65 to 89 wt %) of water.

As described in the first example, in order to quickly discharge the product inside the dehydrogenation reactor 30, when all the products are discharged from the dehydrogenation reactor 30, the pressure of the dehydrogenation reactor 30 may be maintained at the reference pressure (e.g., 1.1 to 1.5 bar).

Therefore, in order to maintain the pressure of hydrogen gas in the dehydrogenation reactor 30 (2 L) at the reference pressure (e.g., 1.5 bar) when all the products are discharged, the volume of hydrogen gas should be 286 mL and the volume of the products should be approximately 1,714 mL while the pressure of hydrogen gas is maintained at the set pressure (e.g., 10.5 bar) before discharging the products.

To this end, in the third example, about 340 mL of an acid aqueous solution and about 1,374 mL of a chemical hydride may be supplied to the dehydrogenation reactor 30, and when the dehydrogenation reaction is completed, hydrogen gas from the dehydrogenation reactor 30 may be discharged to the buffer tank 70 until the pressure of the dehydrogenation reactor 30 is lowered to the set pressure (e.g., 10.5 bar). Thereafter, the product may be discharged from the dehydrogenation reactor 30.

For example, when the internal volume of the dehydrogenation reactor 30 is 2 L, the pressure P1 (e.g., set pressure) of the dehydrogenation reactor 30 before discharging the product is 10.5 bar, and the volume of hydrogen gas is about approximately 286 mL. Therefore, after all the products are discharged, the volume V2 of the dehydrogenation reactor 30 is 2,000 mL, so the dehydrogenation reactor 30 may maintain the reference pressure (e.g., 1.5 bar).

Finally, a dehydrogenation reaction system according to a fourth example will be described in detail with reference to the accompanying drawings.

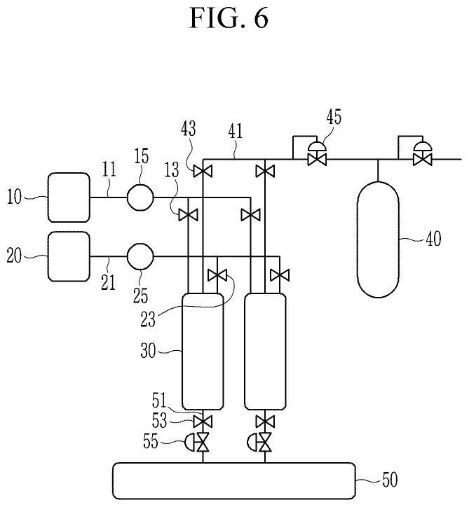

FIG. 6 shows an example of the dehydrogenation reaction system according to the fourth example. The dehydrogenation reaction system shown in FIG. 6 is substantially similar to the dehydrogenation reaction system shown in FIG. 1. Hereinafter, a description will be provided focusing on the differences from the dehydrogenation reaction system of FIG. 1.

The dehydrogenation reaction system according to the fourth example may be provided with a product back pressure regulator 55 in a product discharge line 51 that fluidly connects the dehydrogenation reactor 30 and the product tank 50. The discharge speed (or flow rate) of the product (e.g., liquid waste, by-product solution, or reaction slurry, etc.) discharged from the dehydrogenation reactor 30 may be controlled by the product back pressure regulator 55.

The controller 80 of the dehydrogenation reaction system according to the fourth example may discharge the product (e.g., residual solution, reaction by-product, or neutralized liquid, etc.) generated in the dehydrogenation reactor 30 to the product tank 50 when the dehydrogenation reaction is completed in the dehydrogenation reactor 30. In this case, the controller 80 may discharge the product of the dehydrogenation reactor 30 to the product tank 50 until the internal pressure of the dehydrogenation reactor 30 reaches the set pressure (e.g., decreases to 1.5 bar).

For example, in the fourth example, a set amount of acid aqueous solution and a set amount of chemical hydride may be supplied to the dehydrogenation reactor 30, and after the dehydrogenation reaction is completed, the product generated in the dehydrogenation reactor 30 may be discharged to the product tank 50 (e.g., a sealed storage vessel or neutralization container) until the pressure of the dehydrogenation reactor 30 is lowered to the set pressure (e.g., approximately 1.5 bar). Through this, the loss of hydrogen gas in the dehydrogenation reactor 30 may be reduced or minimized, and only the liquid-phase product (e.g., a neutralized solution or slurry) may be discharged into the product tank 50.

Hereinafter, a control method of the dehydrogenation reaction system according to the fourth example will be described in detail with reference to the accompanying drawings.

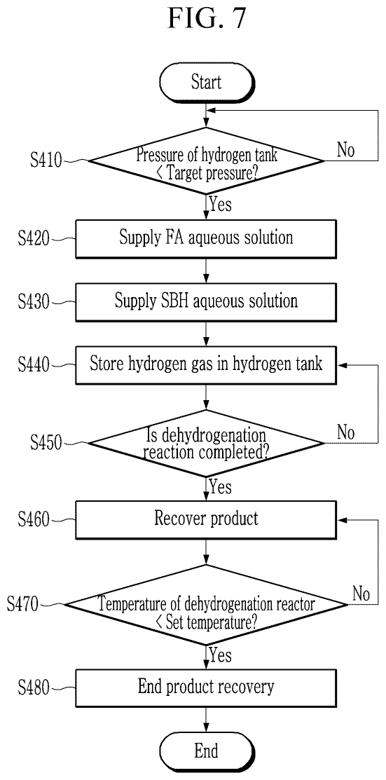

FIG. 7 shows an example of an operation of the dehydrogenation reaction system according to the fourth example.

Referring to FIG. 5, the controller 80 may determine whether the pressure of the hydrogen tank 40 is less than the target pressure (e.g., 875 bar) (S410).

If the pressure of the hydrogen tank 40 is higher than the target pressure, the controller 80 blocks or closes the acid aqueous solution valve 13, the hydride valve 23, and the hydrogen valve 43, and prevents supply of the acid aqueous solution and the chemical hydride to the dehydrogenation reactor 30 (e.g., to avoid over-pressurization, maintain safety, or conserve reagents, etc.).

If the pressure of the hydrogen tank 40 is lower than the target pressure, the controller 80 may supply a set amount of the acid aqueous solution (e.g., 340 mL, 360 mL, 380 mL, or 400 mL, etc.) to the dehydrogenation reactor 30 (S420). To this end, the controller 80 may open the acid aqueous solution valve 13 and operate the acid aqueous solution pump 15 to supply the acid aqueous solution stored in the acid aqueous solution tank 10 to the dehydrogenation reactor 30.

The controller 80 may supply a set amount of chemical hydride (e.g., 1,374 mL, 1,400 mL, 1,450 mL, or 1,500 mL, etc.) to the dehydrogenation reactor 30 (S430). To this end, the controller 80 may open the hydride valve 23 and operate the hydride pump 25 to supply the chemical hydride stored in the chemical hydride tank 20 to the dehydrogenation reactor 30.

When the acid aqueous solution and the chemical hydride are supplied to the dehydrogenation reactor 30, a dehydrogenation reaction occurs in the dehydrogenation reactor 30, and hydrogen gas and products may be generated (e.g., formates, carbonates, or alcohol derivatives, etc.). The hydrogen gas generated in the dehydrogenation reactor 30 may be stored in the hydrogen tank 40 (S440). In this case, the controller 80 opens the hydrogen valve 43 so that the high-pressure hydrogen gas (e.g., 875 bar, 880 bar, or 900 bar, etc.) generated in the dehydrogenation reactor 30 may be supplied to the hydrogen tank 40.

The controller 80 determines whether the dehydrogenation reaction is completed (S450) and may continue supplying the hydrogen gas generated in the dehydrogenation reactor 30 to the hydrogen tank 40 until the dehydrogenation reaction is completed e.g., based on elapsed time, temperature change, or pressure stabilization, etc.). In this case, if a predetermined time has elapsed, the controller 80 may determine that the dehydrogenation reaction has been completed (e.g., after 10 minutes, 20 minutes, or based on sensor feedback, etc.).

When the dehydrogenation reaction is completed, the controller 80 may discharge the product generated in the dehydrogenation reactor 30 into the product tank 50 (S460). To this end, the controller 80 may close the hydrogen valve 43 and open the product valve 53 to discharge the product (e.g., a liquid byproduct, residual slurry, or reaction residue, etc.) of the dehydrogenation reactor 30 into the product tank 50. In this case, the discharge speed of the product may be controlled through the product back pressure regulator 55 (e.g., set to 5 bar, 10 bar, or 20 bar, etc.).

The controller 80 may determine whether the pressure of the dehydrogenation reactor 30 is less than the set pressure (e.g., 125 bar) (S470).

If the pressure of the dehydrogenation reactor 30 is less than the set pressure, the controller 80 does not discharge the product from the dehydrogenation reactor 30 to the product tank 50 (S480). For example, the product of the dehydrogenation reactor 30 may be discharged only until the internal pressure of the dehydrogenation reactor 30 reaches the set pressure (e.g., 125 bar, 120 bar, or 110 bar, etc.).

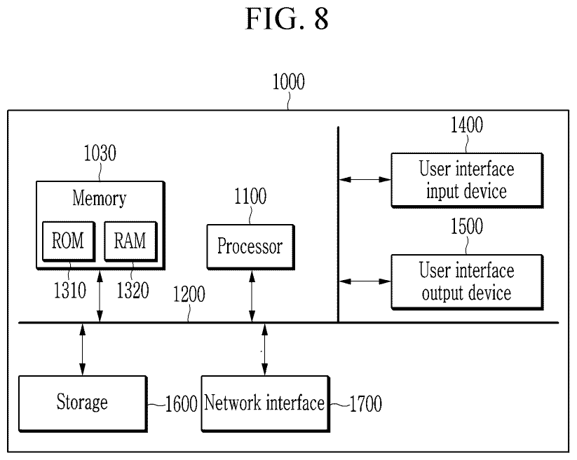

FIG. 8 shows an example computing system (e.g., a computing device of a fuel cell or any other apparatus). One or more controllers, processors, etc. described herein, such as one or more components of the fuel cell system, one or more components of a vehicle, and any other components and devices disclosed herein, may be implemented by or in the computing system as shown in FIG. 8.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example example(s) disclosed in the specification may be directly implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

An example provides a dehydrogenation reaction system including: a dehydrogenation reactor that generates hydrogen gas by a chemical reaction of a chemical hydride and an aqueous acid solution; an acid aqueous solution tank that supplies an acid aqueous solution to the dehydrogenation reactor; a chemical hydride tank that supplies a chemical hydride to the above dehydrogenation reactor; a hydrogen tank that stores high-pressure hydrogen gas generated in the dehydrogenation reactor; a hydrogen back pressure regulator provided in the hydrogen discharge line upstream of the hydrogen tank; a product tank that stores a product generated in the dehydrogenation reactor; and a controller that, so that a pressure of the dehydrogenation reactor is maintained at a reference pressure when the dehydrogenation reaction in the dehydrogenation reactor is completed and all of the products generated in the dehydrogenation reactor are discharged, supplies an acid aqueous solution or water to the dehydrogenation reactor so that the product has a set volume within the dehydrogenation reactor while the hydrogen gas maintains a target pressure before discharging the product and then discharges the product of the dehydrogenation reactor into the product tank.

In some examples, the controller may supply the acid aqueous solution and the chemical hydride to the dehydrogenation reactor, and may additionally supply an acid aqueous solution or water to the dehydrogenation reactor after the dehydrogenation reaction is completed.

Another example provides a control method of a dehydrogenation reaction system, including: determining whether a pressure of a hydrogen tank is less than a target pressure; supplying an acid aqueous solution to a dehydrogenation reactor and supplying a chemical hydride to the dehydrogenation reactor if the pressure of the hydrogen tank is less than the target pressure; storing hydrogen gas generated in the dehydrogenation reactor in a hydrogen tank; supplying, when the dehydrogenation reaction is completed in the dehydrogenation reactor, an acid aqueous solution or water to the dehydrogenation reactor so that the product has a set volume within the dehydrogenation reactor while the hydrogen gas is maintained at a target pressure so that the pressure of the dehydrogenation reactor maintains a reference pressure when all the products of the dehydrogenation reactor are discharged; and discharging the product generated in the dehydrogenation reactor to a product tank.

Another example provides a dehydrogenation reaction system including: a plurality of dehydrogenation reactors that generate hydrogen gas by a chemical reaction of a chemical hydride and an aqueous acid solution; an acid aqueous solution tank that supplies an acid aqueous solution to the dehydrogenation reactor; a chemical hydride tank that supplies a chemical hydride to the above dehydrogenation reactor; a hydrogen tank that stores high-pressure hydrogen gas generated in the dehydrogenation reactor; a hydrogen back pressure regulator provided in the hydrogen discharge line upstream of the hydrogen tank; a product tank that stores a product generated in the dehydrogenation reactor; and a controller that, so that a pressure of one of the dehydrogenation reactors is maintained at a reference pressure when a dehydrogenation reaction in the one of the dehydrogenation reactors is completed and all of the products generated in the one of the dehydrogenation reactors are discharged, discharges hydrogen gas from the one of the dehydrogenation reactors to another of the dehydrogenation reactors while maintaining a set volume ratio between the product and the hydrogen gas before discharging the product and then discharges the product of the dehydrogenation reactor to the product tank.

In some examples, if a temperature of the one of the dehydrogenation reactors is less than a set temperature, the controller may discharge the hydrogen gas from the one of the dehydrogenation reactors to the another of the dehydrogenation reactors.

Another example provides a control method of a dehydrogenation reaction system, including: determining whether a pressure of a hydrogen tank is less than a target pressure; supplying an acid aqueous solution to a dehydrogenation reactor and supplying a chemical hydride to the dehydrogenation reactor if the pressure of the hydrogen tank is less than the target pressure; storing hydrogen gas generated in the dehydrogenation reactor in a hydrogen tank; discharging, so that a pressure of the dehydrogenation reactor is maintained at a reference pressure when all products of the dehydrogenation reactor are discharged in a case that a dehydrogenation reaction is completed in the dehydrogenation reactor, a hydrogen gas of one dehydrogenation reactor to another dehydrogenation reactor while the product and hydrogen gas maintain a set volume ratio; and discharging the product generated in the dehydrogenation reactor to a product tank.

In some examples, in the discharging of the hydrogen gas of the one dehydrogenation reactor to another dehydrogenation reactor, the hydrogen gas of the one dehydrogenation reactor may be discharged to the other dehydrogenation reactor if a temperature of the dehydrogenation reactor is less that a set temperature.

Another example provides a dehydrogenation reaction system including: a plurality of dehydrogenation reactors that generate hydrogen gas by a chemical reaction of a chemical hydride and an aqueous acid solution; an acid aqueous solution tank that supplies an acid aqueous solution to the dehydrogenation reactor; a chemical hydride tank that supplies a chemical hydride to the above dehydrogenation reactor; a hydrogen tank that stores high-pressure hydrogen gas generated in the dehydrogenation reactor; a buffer tank that stores low-pressure hydrogen gas generated in the dehydrogenation reactor; a hydrogen back pressure regulator provided in the hydrogen discharge line upstream of the hydrogen tank; a product tank that stores a product generated in the dehydrogenation reactor; and a controller that, so that a pressure of the dehydrogenation reactor is maintained at a reference pressure when a dehydrogenation reaction in the dehydrogenation reactor is completed and all of the products generated in the dehydrogenation reactor are discharged, discharges hydrogen gas from the dehydrogenation reactor to the buffer tank while maintaining a set volume ratio between the product and the hydrogen gas before discharging the product and then discharges the product of the dehydrogenation reactor to the product tank.

In some examples, the controller may discharge hydrogen gas from the dehydrogenation reactor into the buffer tank until the pressure of the dehydrogenation reactor reaches the reference pressure.

Another example provides a control method of a dehydrogenation reaction system, including: determining whether a pressure of a hydrogen tank is less than a target pressure; supplying an acid aqueous solution to a dehydrogenation reactor and supplying a chemical hydride to the dehydrogenation reactor if the pressure of the hydrogen tank is less than the target pressure; storing hydrogen gas generated in the dehydrogenation reactor in a hydrogen tank; discharging, so that a pressure of the dehydrogenation reactor is maintained at a reference pressure when all products of the dehydrogenation reactor are discharged in a case that a dehydrogenation reaction is completed in the dehydrogenation reactor, a hydrogen gas of the dehydrogenation reactor to a buffer tank while the product and hydrogen gas maintain a set volume ratio; and discharging the product generated in the dehydrogenation reactor to a product tank.

In some examples, in the discharging of the hydrogen gas of the dehydrogenation reactor to the buffer tank, the hydrogen gas of the dehydrogenation reactor may be discharged into the buffer tank until the pressure of the dehydrogenation reactor reaches the reference pressure.

Another example provides a dehydrogenation reaction system including: a dehydrogenation reactor that generates hydrogen gas by a chemical reaction of a chemical hydride and an aqueous acid solution; an acid aqueous solution tank that supplies an acid aqueous solution to the dehydrogenation reactor; a chemical hydride tank that supplies a chemical hydride to the above dehydrogenation reactor; a hydrogen tank that stores high-pressure hydrogen gas generated in the dehydrogenation reactor; a hydrogen back pressure regulator provided in the hydrogen discharge line upstream of the hydrogen tank; a product tank that stores a product generated in the dehydrogenation reactor; a product back pressure regulator that is provided in a product line upstream of the product tank; and a controller that discharges the product generated in the dehydrogenation reactor into the product tank when a dehydrogenation reaction in the dehydrogenation reactor is completed.

In some examples, the controller may discharge the product of the dehydrogenation reactor into the product tank until the pressure of the dehydrogenation reactor reaches a set pressure.

Another example provides a control method of a dehydrogenation reaction system, including: determining whether a pressure of a hydrogen tank is less than a target pressure; supplying an acid aqueous solution to a dehydrogenation reactor and supplying a chemical hydride to the dehydrogenation reactor if the pressure of the hydrogen tank is less than the target pressure; storing hydrogen gas generated in the dehydrogenation reactor in a hydrogen tank; and discharging the product generated in the dehydrogenation reactor into a product tank when a dehydrogenation reaction in the dehydrogenation reactor is completed.

In some examples, in the discharging of the product generated in the dehydrogenation reactor to the product tank, the product of the dehydrogenation reactor may be discharged into the product tank until the pressure of the dehydrogenation reactor reaches a reference pressure.

According to the examples, the product generated by the dehydrogenation reaction in the dehydrogenation reactor may be quickly discharged to the product tank. Through this, the reaction speed of the dehydrogenation reaction system may be improved.

While this disclosure has been described in connection with what is presently considered to be practical examples, it is to be understood that the disclosure is not limited to the disclosed examples, but, on the contrary, is intended to cover various modifications and equivalent arrangements included within the spirit and scope of the appended claims.

What is claimed is:

1. An apparatus of a fuel cell system, the apparatus comprising:
a dehydrogenation reactor configured to generate, based on a chemical reaction of a chemical hydride and an aqueous acid solution, hydrogen gas;
an acid aqueous solution tank configured to supply the acid aqueous solution to the dehydrogenation reactor;
a chemical hydride tank configured to supply the chemical hydride to the dehydrogenation reactor;
a hydrogen tank configured to store the hydrogen gas generated in the dehydrogenation reactor, wherein the hydrogen gas stored in the hydrogen tank is stored under a first pressure;
a hydrogen back pressure regulator disposed along a hydrogen discharge path between the dehydrogenation reactor and the hydrogen tank;
a product tank configured to store a product generated in the dehydrogenation reactor;
a processor; and
a memory storing at least one instruction that, when executed by the processor communicating with the memory, is configured to cause the apparatus to:
control a pressure of the dehydrogenation reactor, to maintain a reference pressure after a dehydrogenation reaction in the dehydrogenation reactor is completed and the product generated in the dehydrogenation reactor is discharged, wherein the pressure of the dehydrogenation reactor is controlled by:
before discharging the product generated in the dehydrogenation reactor into the product tank, supplying an acid aqueous solution or water to the dehydrogenation reactor so that the product has a set volume within the dehydrogenation reactor while the hydrogen gas is maintained at a target pressure.

2. The apparatus of claim 1, wherein the at least one instruction, when executed by the processor communicating with the memory, is configured to cause the apparatus to:
supply the acid aqueous solution and the chemical hydride to the dehydrogenation reactor, and
supply additional acid aqueous solution or water to the dehydrogenation reactor after the dehydrogenation reaction is completed.

3. The apparatus of claim 1, wherein the product is discharged until an internal pressure of the dehydrogenation reactor reaches a set pressure.

4. The apparatus of claim 1, further comprising a product back pressure regulator disposed along a product discharge path between the dehydrogenation reactor and the product tank.

5. The apparatus of claim 1, further comprising a buffer tank configured to store hydrogen gas from the dehydrogenation reactor, wherein the hydrogen gas stored in the buffer tank is stored under a second pressure that is lower than the first pressure.

6. The apparatus of claim 5, wherein the at least one instruction, when executed by the processor communicating with the memory, is configured to cause the apparatus to discharge hydrogen gas from the dehydrogenation reactor to the buffer tank until a pressure of the dehydrogenation reactor reaches the reference pressure.

7. The apparatus of claim 1, wherein the chemical hydride and acid aqueous solution are each supplied in liquid form to reduce or remove handling of solid-phase reactants.

8. The apparatus of claim 1, wherein the hydrogen gas is stored at a pressure in a range of 500 bar to 875 bar in the hydrogen tank.

9. A method performed by an apparatus of a fuel cell system, the method comprising:
determining whether a pressure of a hydrogen tank of the fuel cell system is less than a target pressure;
based on the pressure of the hydrogen tank being less than the target pressure, supplying an acid aqueous solution to a dehydrogenation reactor of the fuel cell system and supplying a chemical hydride to the dehydrogenation reactor;
storing hydrogen gas generated in the dehydrogenation reactor in the hydrogen tank; and
controlling a pressure of the dehydrogenation reactor, to maintain a reference pressure after a dehydrogenation reaction in the dehydrogenation reactor is completed and a product generated in the dehydrogenation reactor is discharged, wherein the controlling of the pressure of the dehydrogenation reactor comprises;
supplying an acid aqueous solution or water to the dehydrogenation reactor so that the product has a set volume within the dehydrogenation reactor while the hydrogen gas is maintained at a set pressure; and
discharging the product to a product tank.

10. The method of claim 9, further comprising:
discharging the product until a pressure of the dehydrogenation reactor reaches a set pressure.

11. The method of claim 9, wherein the supplying of the acid aqueous solution or water and the supplying of chemical hydride reduce or remove handling of a solid-phase chemical hydride.

12. The method of claim 9, further comprising:
discharging hydrogen gas to another dehydrogenation reactor or a buffer tank to reduce an internal pressure of the dehydrogenation reactor before discharging the product.

13. The method of claim 12, wherein the discharging of hydrogen gas is performed based on a temperature of the dehydrogenation reactor being below a set threshold.

14. An apparatus of a fuel cell system, the apparatus comprising:
a plurality of dehydrogenation reactors configured to generate, based on a chemical reaction of a chemical hydride and an aqueous acid solution, hydrogen gas;
an acid aqueous solution tank configured to supply an acid aqueous solution to the plurality of dehydrogenation reactors;
a chemical hydride tank configured to supply a chemical hydride to the plurality of dehydrogenation reactors;
a hydrogen tank configured to store hydrogen gas generated in the plurality of dehydrogenation reactors;
a hydrogen back pressure regulator disposed along a hydrogen discharge path between the plurality of dehydrogenation reactors and the hydrogen tank;
a product tank configured to store products generated in the plurality of dehydrogenation reactors;
a processor; and
a memory storing at least one instruction that, when executed by the processor communicating with the memory, is configured to cause the apparatus to:
control a pressure of one of the plurality of dehydrogenation reactors to maintain a reference pressure after a dehydrogenation reaction in the one of the plurality of dehydrogenation reactors is completed and a respective product generated in the one of the plurality of dehydrogenation reactors is discharged, wherein the pressure of the one of the plurality of dehydrogenation reactors is controlled by:
before discharging the respective product to the product tank, discharge hydrogen gas from the one of the plurality of dehydrogenation reactors to another of the plurality of dehydrogenation reactors while maintaining a set volume ratio between the respective product and the hydrogen gas in the one of the plurality of dehydrogenation reactors.

15. The apparatus of claim 14, wherein the at least one instruction, when executed by the processor communicating with the memory, is configured to cause the apparatus to:
based on a temperature of the one of the plurality of dehydrogenation reactors being less than a set temperature, discharge the hydrogen gas from the one of the plurality of dehydrogenation reactors to the other of the plurality of dehydrogenation reactors.

16. The apparatus of claim 14, wherein the respective product is discharged to the product tank until a pressure of the one of the plurality of dehydrogenation reactors reaches a set value.

17. The apparatus of claim 14, wherein the plurality of dehydrogenation reactors are configured to operate alternately to support continuous hydrogen generation.

18. The apparatus of claim 14, wherein the at least one instruction, when executed by the processor communicating with the memory, is configured to cause the apparatus to control, based on measured internal pressure or temperature of a first dehydrogenation reactor of the plurality of dehydrogenation reactors, discharge of hydrogen gas from the first dehydrogenation reactor.

19. The apparatus of claim 14, wherein the hydrogen gas is discharged from the one of the plurality of dehydrogenation reactors to the other of the plurality of dehydrogenation reactors to adjust a pressure of the one of the plurality of dehydrogenation reactors before discharging a product from the one of the plurality of dehydrogenation reactors.

20. The apparatus of claim 14, wherein a volume of a product generated in the one of the plurality of dehydrogenation reactors is determined based on a preset internal volume of the one of the plurality of dehydrogenation reactors and a preset gas volume of hydrogen gas maintained under pressure within the one of the plurality of dehydrogenation reactors.
